(19) United States
(12) Patent Application Publication
(10) Pub. No.: US 2004/0054925 A1
(43) Pub. Date: Mar. 18, 2004

(54) System and method for detecting and countering a network attack

(75) Inventors: James K. Etheridge, Jupiter, FL (US); Richard N. Anton, Jupiter, FL (US)

Correspondence Address: KING & SPALDING, 191 PEACHTREE STREET, N.E., ATLANTA, GA, 30303-1763, US

(73) Assignee: Cyber Operations, LLC, Jupiter, FL (US)

(21) Appl. No.: 10/243,631

(22) Filed: Sep. 13, 2002

(51) Int. Cl. G06F 11/30; G06F 15/173

(52) U.S. Cl. 713/201; 713/181; 709/224

(57) ABSTRACT

Protecting a host network from a flood-type denial of service attack by performing statistical analysis of data packets in the network. The statistical analysis comprises comparing evaluated items in the data packets to threshold values and detecting the attack when the statistical items exceed the threshold value. A countermeasure can be initiated to protect the host network from the attack.

### RELATED APPLICATIONS

This application is related to U.S. patent application Ser. No. 10/086,107, entitled “System and Method for Anti-Network Terrorism,” filed Feb. 28, 2002, and to U.S. Provisional Patent Application No. 60/272,712, entitled “System and Method for Anti-Network Terrorism,” filed Mar. 1, 2001. The complete disclosure of each of the above-identified related applications is fully incorporated herein by reference.

### FIELD OF THE INVENTION

The present invention relates generally to a system and method for detecting and countering a network attack. More particularly, the present invention relates to a passive network attack detection system and method with countermeasure technology that can prevent network flood interruptions without disrupting normal network operations.

### BACKGROUND OF THE INVENTION

The security of computing networks is an increasingly important issue. With the growth of wide area networks (WANs), such as the Internet and the World Wide Web, people rely on computing networks to transfer and store an increasing amount of valuable information. In today's computing environment, companies, schools, organizations, and other enterprises ordinarily operate a host network to communicate and store electronic documents and information. Each host network typically provides access to other host networks or wide area networks allowing an increased flow of information.

Attacks on host network computer systems are an increasing problem for e-commerce companies, network communications providers, organizations, and governments. In a “denial of service” (DOS) attack on a host network, an attacker attempts to prevent legitimate users from accessing services provided by a particular host network. DOS attacks can essentially disable a single computer or an entire host network. Such a disruption in service can be costly to the host network provider in terms of lost revenue, repair costs, and lost productivity during the disruption.

DOS attacks come in a variety of forms and aim at a variety of services. Computers and networks require network bandwidth, memory, disk space, CPU time, and access to other computers and networks to operate. Attacks on a host network can disrupt any of those items to be effective. Typically, an attacker executes a DOS attack against the host network's connectivity to prevent the host network from communicating outside its environment.

One way to attack the host network's connectivity involves exploiting flaws in the TCP stack. The attacker establishes a connection to a victim computer of the host network. However, the attacker establishes the connection in such a way as to prevent the ultimate completion of the connection. In the meantime, the victim computer has reserved one or more of a limited number of data structures required to complete the impending connection. Accordingly, the attack denies legitimate connections while the victim computer waits to complete each “half-open” connection.

Another method for initiating a denial of service attack involves exploiting security holes in an existing network to gain access. Once inside the network, the attacker can disrupt network service by attacking the network' connectivity.

In today's network environment, the most problematic type of DOS attack includes “flooding” a host network with information. The flood of information can consume all available bandwidth of the host network's computing resources, thereby preventing legitimate network traffic from reaching the host network and preventing an individual user from accessing the services of the host network. The attacker can consume bandwidth through a network flood by generating a large number of packets, or a small number of extremely large packets, directed to the target network. Typically, those packets comprise Internet control message protocol (ICMP) ECHO packets, a user datagram protocol (UDP) stream attack, or a TCP SYN flood. In principle, however, the packets can include any form.

The attacker can execute the flood attack from a single computer. Alternatively, the attacker can coordinate or co-opt several computers on different networks to achieve the same effect. Using several computers for an attack is commonly referred to as a distributed denial of service (DDOS) attack. The attacker also can falsify (spoof) the source IP address of the packets, thereby making it difficult to trace the identity of computers used to carry out the attack. Spoofing the source IP address also can shift attention onto innocent third parties.

An attacker also can execute a more defined attack using spoofed packets called “Broadcast Amplification” or a “Smurf attack.” In this common attack, the attacker generates packets with a spoofed source address of the target. The attacker then sends a series of network requests using the spoofed packets to an organization having many computers. The packets contain an address that broadcast the packets to every computer at the organization. Every computer at the organization then responds to the spoofed packet requests and sends data to the target site. Accordingly, the target becomes flooded with the responses from the organization. Additionally, the target site may blame the organization for the attack.

Conventional methods for handling a DOS attack typically have focused on detecting an attack that exploits security holes or establishes half-open connections. For example, a conventional intrusion detection system (IDS) can detect an attacker's entry into a server. Such a system typically operates on the server itself and can detect only an entry into the specific server. Additionally, a conventional IDS cannot detect and counter a flood-type DOS attack.

Conventional firewall and router techniques also exist for attempting to handle problems associated with a flood attack. However, conventional firewall techniques also are insufficient to detect and counter a flood-type DOS attack. Firewall techniques typically involve comparing a header of incoming data packets to specific, known flood attacks. However, hundreds of specific, known flood attacks exist, and comparing the packet information to each attack can require a significant amount of time. Accordingly, such a process costs valuable response time before taking action to protect the network, which can allow the network to become overwhelmed by the incoming packets. Additionally, conventional firewall techniques cannot detect an unknown or new attack.

Conventional router techniques also are insufficient to detect and counter a flood-type DOS attack. A conventional router can monitor peak traffic flow. If the traffic flow exceeds a specified amount, then the router will limit the traffic flowing through it, thereby maintaining traffic flow below the specified limit. Accordingly, a large number of requests can back up at the router in the event of a flood-type DOS attack. Eventually, the traffic flow becomes choked and the router shuts down. Furthermore, conventional router techniques only evaluate traffic flow and cannot detect or counter a flood attack. When the router limits traffic flow, the attacking packets still arrive at the router, contributing to the choking problem discussed above.

Accordingly, there is a need in the art for a system and method that can detect and counter a network attack. Specifically, a need exists for a system and method that can passively monitor incoming data packets and can detect the network attack based on statistical analysis of data packets, rather than based upon specific, known attacks and their corresponding signatures. More specifically, a need exists in the art for detecting a network attack based on standard deviation analysis, packet error analysis, packet parameter analysis, and packet ratio analysis. Additionally, a need exists for countering the network attack by blocking only the minimum amount of traffic to stop the attack. Accordingly, a need exists for countering a network attack based on a source IP address, a common port or protocol, or a destination address.

### SUMMARY OF THE INVENTION

The present invention can provide a system and method for detecting and countering a flood-type DOS attack. The present invention can detect a network attack by performing statistical analysis on data packets transmitted over the network to determine when the data packets vary from normal network traffic. Normal network traffic can be determined based on observations of network traffic for a particular network. Then, a user can establish thresholds for abnormal network traffic based on the observations and on a balance between security level and false positive indications. A lower threshold can result in higher security but also more false positive indications. On the other hand, a higher thresher can result in lower security but fewer false positive indications.

After establishing the thresholds, the present invention can statistically analyze the network traffic to determine when the traffic exceeds the thresholds. If the traffic exceeds the thresholds, an attack is detected. Then, a countermeasure can be initiated to block data packets from an IP address. A countermeasure also can be initiated to block data packets to or from a common port, data packets having a common protocol, or data packets having the target destination IP address.

In one aspect, the present invention can perform a hash, or “reduction,” function on network data packets and can sort the data packets in a hash table based on the result of the hash. If the standard deviation of the entries in the hash table exceeds a threshold value, then a network attack can be detected.

In another aspect, the present invention can monitor a parameter value such as protocol or protocol flags of network data packets. The present invention can construct a histogram of the parameter value and can compare the histogram to a threshold value. If a portion of the histogram exceeds the threshold, then a network attack can be detected.

In yet another aspect, the present invention can monitor network data packets and can count data packets that represent or convey an error. If the error count exceeds a threshold value, then a network attack can be detected.

In another aspect, the present invention can monitor the ratio of incoming and outgoing data packets for a single computer. If the ratio exceeds a threshold value, then the present invention can detect a network attack. Alternatively, the ratio of traffic from computer A to computer B over the traffic from computer B to computer A can be monitored. If the ratio exceeds a threshold value, then a network attack can be detected.

The present invention also can provide a system and method for countering a flood-type DOS attack. By determining whether the attack was initiated from a single source, or by data packets having a common port or protocol, the attack can be countered without disrupting normal system operations. If the attack was initiated from a single source, then data packets having the attacking source IP address can be prevented from reaching the host server. Additionally, if the attack was initiated by data packets having a common port or protocol, then data packets having the common port or protocol can be prevented from reaching the host server, similar to blocking packets having the single source IP address. Other identifying information, such as the destination address, the destination port, or the content of the data packet itself, can be used to prevent data packets from reaching the host server.

These and other aspects, objects, and features of the present invention will become apparent from the following detailed description of the exemplary embodiments, read in conjunction with, and reference to, the accompanying drawings.

### BRIEF DESCRIPTION OF THE DRAWINGS

FIG. 1 is a block diagram depicting a representative operational environment of an anti-network terrorism system constructed in accordance with an exemplary embodiment of the present invention.

FIG. 2 is a block diagram depicting an anti-network terrorism system according to an exemplary embodiment of the present invention.

FIG. 3 is a flow chart depicting a method for detecting and countering a network attack according to an exemplary embodiment of the present invention.

FIG. 4 is a flowchart depicting a method for identifying a source of a network attack according to an exemplary embodiment of the present invention.

FIG. 5 is a flow chart depicting a method for initiating a defensive countermeasure for a single source attack according to an exemplary embodiment of the present invention.

FIG. 6 is a flowchart depicting a method for detecting a network attack according to an alternative exemplary embodiment of the present invention.

FIG. 7 is a flowchart depicting a method for setting a threshold value according to an exemplary embodiment of the present invention.

FIG. 8 is a flowchart depicting a method for removing/decaying data packets from analysis according to an exemplary embodiment of the present invention.

FIG. 9 is a flowchart depicting a method for detecting a network attack according to another alternative exemplary embodiment of the present invention.

FIG. 10 is a flowchart depicting a method for detecting a network attack according to another alternative exemplary embodiment of the present invention.

FIG. 11 is a flowchart depicting a method for detecting a network attack according to another alternative exemplary embodiment of the present invention.

FIG. 12 is a flowchart depicting a method for detecting a network attack according to another alternative exemplary embodiment of the present invention.

### DETAILED DESCRIPTION OF EXEMPLARY EMBODIMENTS

The present invention can provide a passive detection system with countermeasure deployment technology, which can prevent denial of service (DOS) and distributed denial of service (DDOS) flood interruptions without disrupting normal network operations. The system according to the present invention can monitor data packets for data content through the use of software that essentially analyzes network traffic. That method can provide the system with the ability to monitor traffic transmitted and received by the host system. Additionally, network administrators can establish data load thresholds and statistical thresholds on both the inbound and outbound traffic flows, resulting in the ability to differentiate between normal and abnormal network behavior. If the system detects an attack, the load threshold can be used to confirm the attack prior to initiating a countermeasure.

Although the exemplary embodiments will be generally described in the context of software modules running in a distributed computing environment, those skilled in the art will recognize that the present invention also can be implemented in conjunction with other program modules for other types of computers. In a distributed computing environment, program modules may be physically located in different local and remote memory storage devices. Execution of the program modules may occur locally in a stand-alone manner or remotely in a client/server manner. Examples of such distributed computing environments include local area networks of an office, enterprise-wide computer networks, and the global Internet.

The detailed description which follows is represented largely in terms of processes and symbolic representations of operations in a distributed computing environment by conventional computer components, including database servers, application servers, mail servers, routers, security devices, firewalls, clients, workstations, memory storage devices, display devices and input devices. Each of these conventional distributed computing components is accessible via a communications network, such as a wide area network or local area network.

The processes and operations performed by the computer include the manipulation of signals by a client or server and the maintenance of these signals within data structures resident in one or more of the local or remote memory storage devices. Such data structures impose a physical organization upon the collection of data stored within a memory storage device and represent specific electrical or magnetic elements. These symbolic representations are the means used by those skilled in the art of computer programming and computer construction to most effectively convey teachings and discoveries to others skilled in the art.

The present invention also includes a computer program which embodies the functions described herein and illustrated in the appended flow charts. However, it should be apparent that there could be many different ways of implementing the invention in computer programming, and the invention should not be construed as limited to any one set of computer program instructions. Further, a skilled programmer would be able to write such a computer program to implement the disclosed invention based on the flow charts and associated description in the application text, for example. Therefore, disclosure of a particular set of program code instructions is not considered necessary for an adequate understanding of how to make and use the invention. The inventive functionality of the claimed computer program will be explained in more detail in the following description in conjunction with the remaining figures illustrating the program flow.

Referring now to the drawings, in which like numerals represent like elements throughout the figures, aspects of the present invention and the preferred operating environment will be described.

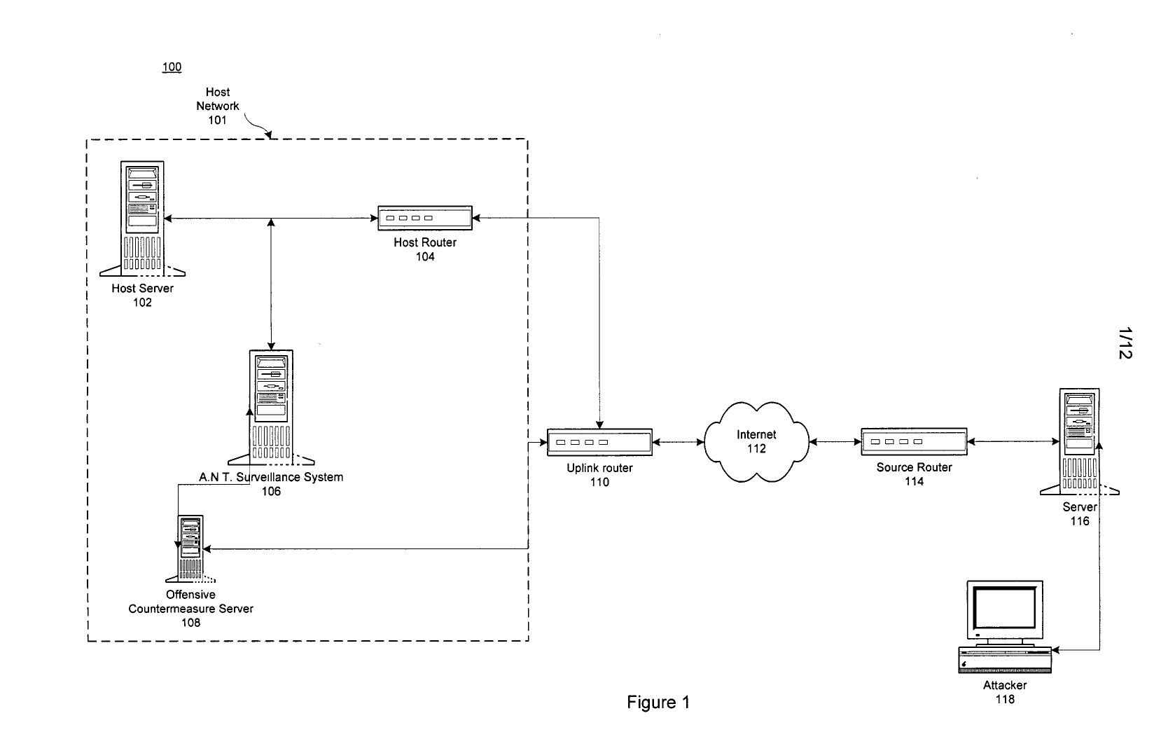

FIG. 1 is a block diagram depicting a representative operational environment 100 of an anti-network terrorism (A.N.T.) system constructed in accordance with an exemplary embodiment of the present invention. As shown in FIG. 1, a host network 101 can include a host server 102 and a host router 104. Host router 104 can be coupled to the Internet 112 by an uplink router 110 that provides Internet services to host network 101. Additionally, an attacker 118 can connect to host system 101 through the Internet 112. Typically, attacker 118 connects to a server 116. From server 116, data from attacker 118 travels to a source router 114 across Internet 112 to uplink router 110. From uplink router 110, data from attacker 118 can be transferred to host router 104 of host network 101.

To prevent data from attacker 118 from reaching host server 102, host network 101 can include an A.N.T. system 106 according to an exemplary embodiment of the present invention. System 106 can connect to host network 101 between host router 104 and host server 102. Accordingly, system 106 can monitor data sent between host router 104 and host server 102 to detect a flood type DOS attack, as well as other types of attack. The exemplary system 106 can be positioned in front of a firewall (not shown) of host system 101. After system 106 detects an attack, it can activate a defensive countermeasure at host router 104 to protect host network 101 from the attack.

Additionally, system 106 can be connected to an offensive countermeasure server 108, which can provide a pathway for initiating an offensive countermeasure against attacker 118. In this regard, system 106, together with offensive countermeasure server 108, can provide a management platform to control and initiate any available offensive capability. External programs can be integrated into, and launched from, system 106 to implement an offensive countermeasure. Offensive countermeasure server 108 can be located within host network 101 as shown in FIG. 1. Alternatively, offensive countermeasure server can be located outside of the architecture of host network 101 (not shown), which can hide the identity of host network 101 when initiating an offensive countermeasure.

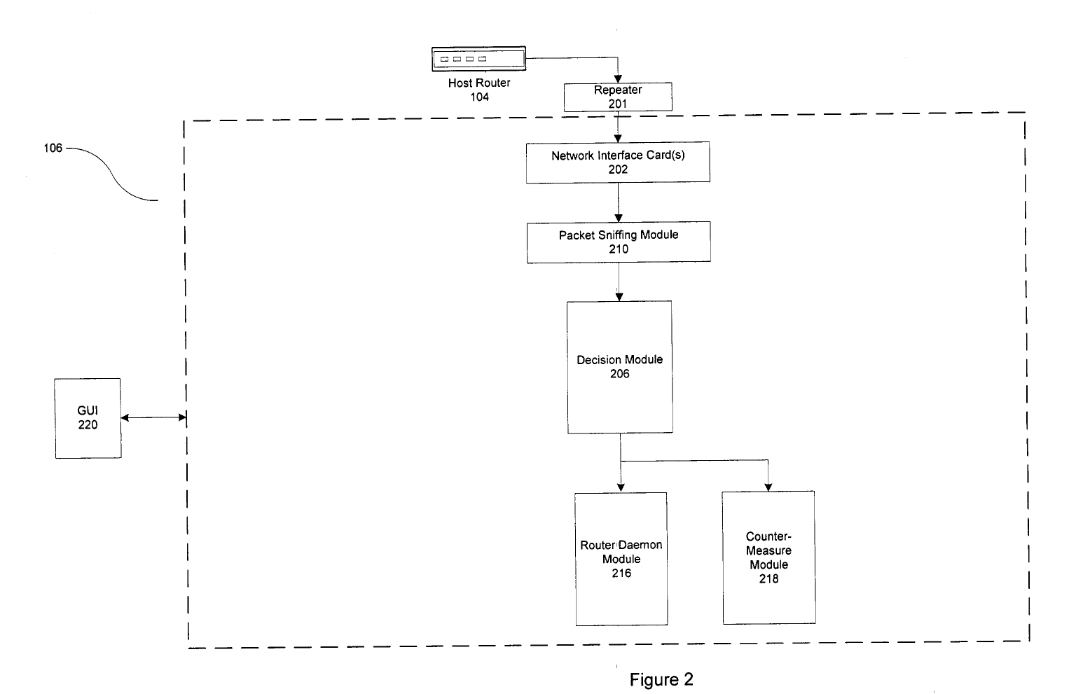

FIG. 2 is a block diagram depicting the system 106 according to an exemplary embodiment of the present invention. System 106 can include a repeater 201 and one or more network interface cards 202 for connecting system 106 to host router 104. Packet sniffing module 210 can collect and analyze data packets transferred from host router 104 to host server 102. Decision module 206 can perform statistical analysis of the data packets to detect a network attack.

The decision module 206 receives data from the packet sniffing module 210 and can determine whether host network 101 (FIG. 1) is under attack. If the decision module 206 determines there is an attack, it can interact with router daemon module 216 and countermeasure module 218 to suggest a countermeasure. Countermeasure module 218 can then initiate a countermeasure against either the single source or the multiple sources. Additionally, countermeasure module 218 can initiate a countermeasure against sources, or against the data packets having a common port or protocol. Router daemon module 216 can interact with countermeasure module 218 to apply the countermeasure to an interface of host router 104 and to uplink router 110.

A graphical user interface (GUI) 220 can be provided for allowing a user to interact with system 106.

The flow charts discussed below further describe the operation of the components depicted in FIG. 2, particularly the decision module 206 and the recommendation module 208.

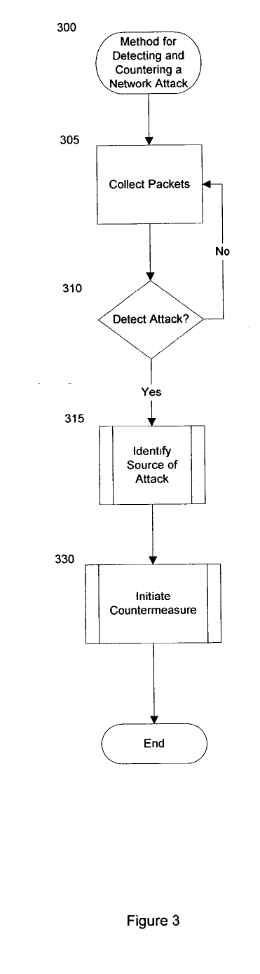

FIG. 3 is a flow chart depicting a method 300 for detecting and countering a network attack according to an exemplary embodiment of the present invention. In step 305, packets can be collected for analysis. Decision module 206 analyzes the collected packets in step 310 and determines whether there has been an attack upon host network 101. If decision module 206 has not detected an attack, then the method can return to step 305 to collect additional packets.

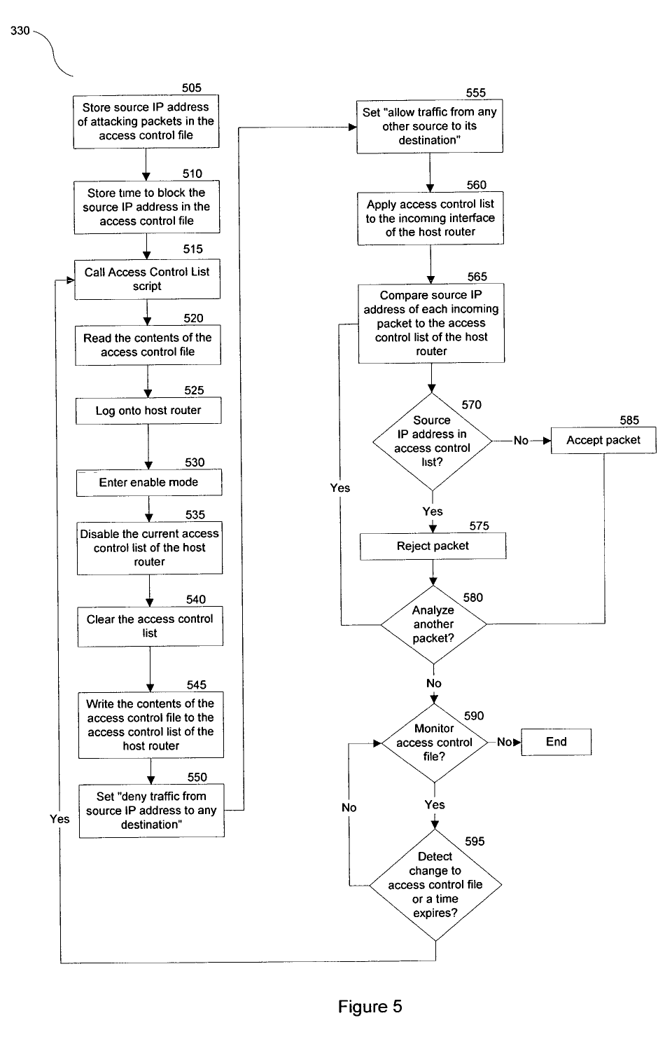

If an attack is detected in step 310, the trace route module 214 identifies a source of the attack. The method can then proceed to step 330, where a countermeasure can be initiated. An example of a countermeasure is discussed in greater detail below in connection with FIG. 5.

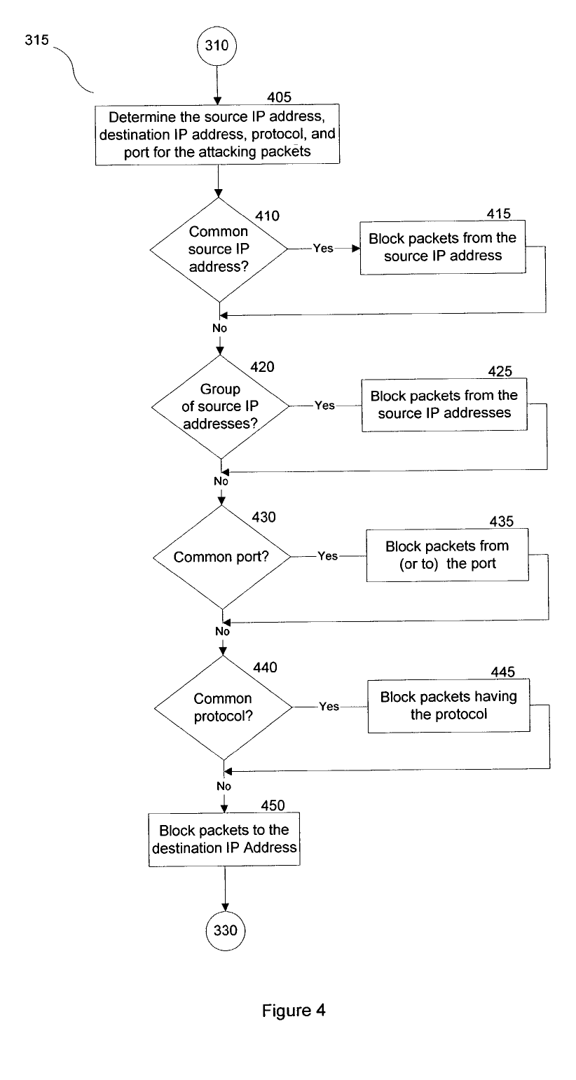

FIG. 4 is a flowchart depicting a method 315 for identifying a source of a network attack according to an exemplary embodiment of the present invention, as referred to in step 315 of FIG. 3. In step 405, the decision module 206 determines the source IP address, destination IP address, protocol, and port for the attacking data packets. In step 410, the decision module 206 determines whether the attacking data packets comprise a common source IP address. For example, the method 315 can identify a common IP address if a large portion of the attacking packets initiate from a single source. If yes, then the method branches to step 315. In step 315, the decision module 206 provides a signal to block data packets from the common source IP address. The method then proceeds to step 330 (FIG. 3) to initiate a countermeasure by blocking data packets from the source IP address.

If the method 315 determines in step 410 that the attacking data packets do not comprise a common source IP address, then the method branches to step 420. In step 420, the decision module 206 determines whether the attacking data packets comprise a group of source IP addresses. For example, the method 315 can identify a common IP address if a large portion of the attacking packets initiate from several common single sources. If not, then the method branches to step 430. If yes, then the method branches to step 425. In step 425, the decision module 206 provides a signal to block data packets from each source IP address of the attacking data packets. The method then proceeds to step 330 (FIG. 3) to initiate a defensive countermeasure. In that regard, the method performed in step 330 can block each source IP address from the group of source IP addresses.

In step 430, the decision module 206 determines whether the attacking data packets are directed to, or originate from, a common port. If not, then the method branches to step 440. If yes, then the method branches to step 435. In step 435, the decision module 206 provides a signal to block data packets from (or to) the common port. The method then branches to step 330 (FIG. 3) to initiate a defensive countermeasure. In that regard, the method of step 330 can block packets for the common port similarly to blocking packets associated with an IP address.

In step 440, the decision module 206 determines whether the attacking data packets comprise a common protocol. For example, the protocol can comprise TCP, UDP, or ICMP. If not, then the method branches to step 450. If yes, then the method branches to step 445. In step 445, the decision module 206 provides a signal to block data packets having the common protocol. For example, if the common protocol is ICMP, then the decision module 206 can provide a signal to block data packets of the ICMP protocol. The method then proceeds to step 330 (FIG. 3) to initiate a defensive countermeasure. In that regard, the method of step 330 can block data packets associated with the common protocol in a similar manner to blocking data packets associated with an IP address.

If the method reaches step 450, then the decision module 206 has determined that the attacking data packets do not comprise a common source IP address, a group of source IP addresses, a common port, or a common protocol. Accordingly, the decision module 206 has determined that the attacking data packets originated from randomly generated sources. Accordingly, the decision module 206 provides a signal in step 450 to block data packets to the destination IP address of the attacking data packets. The method then proceeds to step 330 (FIG. 3) to initiate a countermeasure by blocking data packets having the destination IP address.

Accordingly, the exemplary embodiment of FIG. 4 can initiate the least restrictive defensive countermeasure necessary to counter the network attack. For example, if a common source IP address is identified, then only data packets having that source IP address are blocked.

FIG. 5 is a flow chart depicting a method for initiating a defensive countermeasure for a single source attack according to an exemplary embodiment of the present invention, as referred to in step 330 of FIG. 3. Router daemon module 216 can execute the steps illustrated in FIG. 5 to initiate the single source countermeasure. In step 505, router daemon module 216 can store the source IP address of the attacking packets in an access control file. In step 510, router daemon module 216 also can store in the access control file a time to block the source IP address.

In step 515, an access control list script can be executed to implement the single source countermeasure at host router 104. In step 520, the contents of the access control file can be read. Router daemon module 216 can then log onto host router 104 in step 525. In step 530, enable mode can be activated to allow changes to an access control list of host router 104. In step 535, the access control list script can disable the current access control list of host router 104. Then in step 540, the access control list of host router 104 can be cleared. The contents of the access control file can then be written to the access control list of host router 104 in step 545.

The host router can then be configured to deny or allow certain traffic destined for host network 101. In step 550, the access control list script can set host router 104 to “deny traffic from the source IP address to any destination.” Then in step 555, the access control list script can set host router 104 to “allow traffic from any other source to its destination.” In step 560, the access control list can be applied to the incoming interface of host router 104. At this point, the initiation of the single source countermeasure is complete. The following steps describe the operation of host router 104 to protect host network 101 from attack based on the single source countermeasure.

In step 565, host router 104 can compare the source IP address of each incoming packet to the access control list. Accordingly, host router 104 can determine in step 570 whether the access control list includes the source IP address. If the access control list includes the source IP address, then the packet can be rejected in step 575. The method can then proceed to step 580, where host router 104 can determine whether additional packets remain to be analyzed. If host router 104 determines in step 570 that the access control list does not include the source IP address, then the packet can be accepted in step 585 before proceeding to step 580. Accordingly, the exemplary method only rejects packets having the attacking source IP address. The countermeasure does not affect packets having another source IP address.

If additional packets remain to be analyzed in step 580, then the method can branch back to step 565 to continue processing the incoming packets. If additional packets do not remain, then the method can branch to step 590. In step 590, router daemon module 216 can monitor the access control file. In step 585, router daemon module 216 can determine whether a new source IP address has been added to the access control file, or whether a block time has expired for a source IP address listed in the access control file. If the method detects such a change to the access control file, the method can branch back to step 515 to update the access control list of host router 104. If step 585 does not detect such a change, then the method can branch back to step 590 to continue monitoring the access control file. If router daemon module 216 will not monitor the access control file in step 590, then the method can proceed to step 335 (FIG. 3).

Thus, the exemplary method can provide “one-click” implementation of the access control file to host router 104. That “one-click” implementation can update the host router 104 to deny traffic having the attacking source IP address. Router daemon module 216 can comprise a program used by the A.N.T. server to interface with host router 104. Router daemon module 216 essentially can create a telnet session for the A.N.T. server and can execute router scripts (a series of commands for the router operating system) that perform specific functions. Router daemon module 216 also can import external variables from other information sources. Whether passed to router daemon module 216 via the command line, or stored in a config file, router daemon module 216 can import the data and can use it in conjunction with the router scripts. Accordingly, a single script can be executed each time a new attacking IP address or target IP address is identified, and router daemon module 216 can import that IP address to be used within the script.

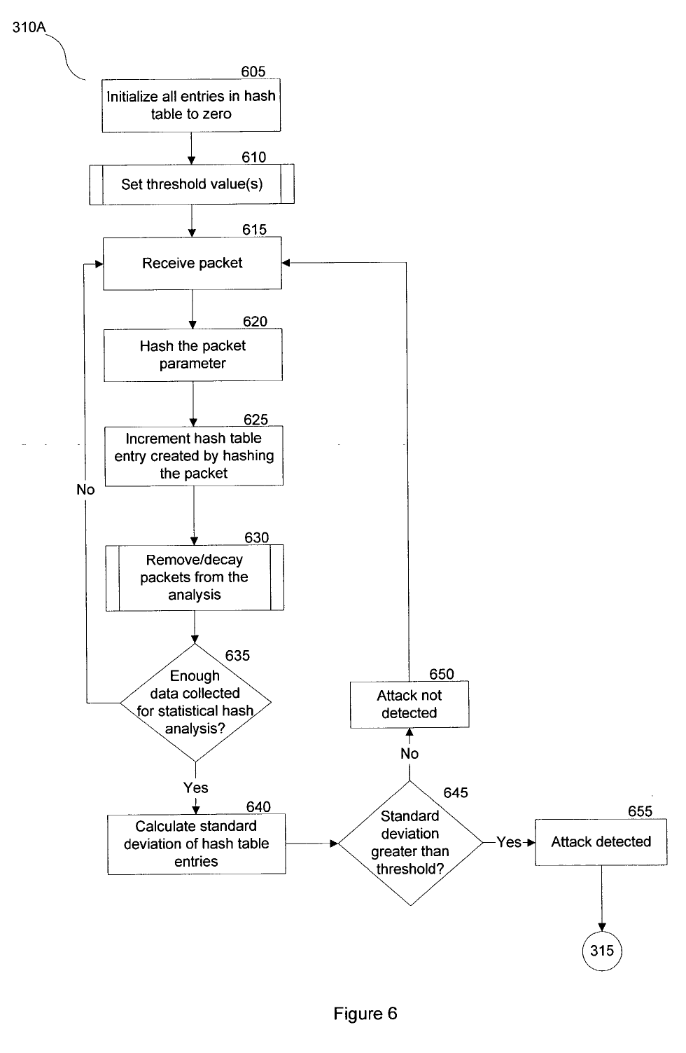

FIG. 6 is a flowchart depicting a method 310A for detecting a network attack according to an alternative exemplary embodiment of the present invention, as referred to in step 310 of FIG. 3. The method 310A utilizes a hash table to evaluate parameters of data packets received by the network. As data packets are received, the method 310A performs a reduction hash function to sort the packets and increment a corresponding entry in the hash table. Then, the method 310A evaluates the hash table to determine if the network is under attack. The method 310A can evaluate a number of different parameters either individually or simultaneously. For example, the parameters can include source IP address, destination IP address, and source port. A hash table can be established for each parameter evaluated by the method 310A.

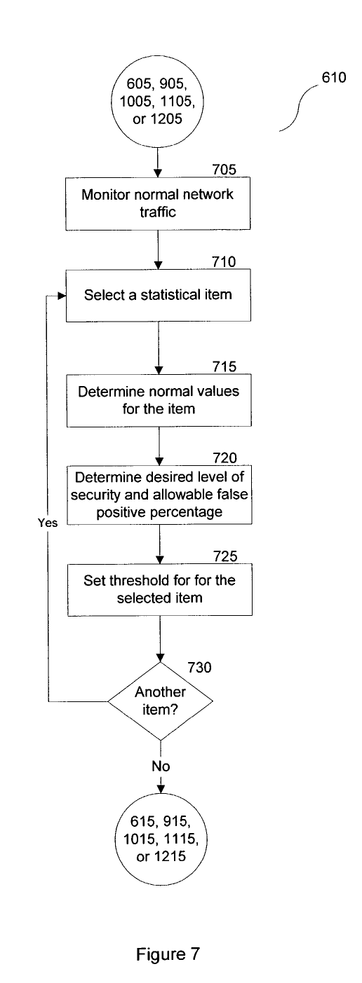

In step 605 of FIG. 6, the decision module 206 can initialize all entries in a hash table to zero. In step 610, a standard deviation threshold value can be established for each parameter based on normal network traffic and a balance of network security and false positive indications, as described in detail below with reference to FIG. 7.

In step 615, the decision module 206 receives a data packet. In step 620, the decision module 206 hashes a parameter of the received data packet using a hash, or “reduction,” function. The hash function can reduce a large amount of data into a reasonable amount of data for evaluation. For example, the method 310A can evaluate a source IP address parameter for each received data packet. Because a relatively unlimited number of source IP addresses exist, evaluating the entire source IP address can be burdensome. Accordingly, a hash function can be used to reduce each source IP address to a smaller amount of data for evaluation. For example, the source IP address parameter can be divided by a set number. The remainder can comprise the “hash,” which can be used to sort the IP addresses in a hash table. For instance, the hash table can comprise one-hundred entries. After determining the remainder for a data packet source IP address, the hash table entry corresponding to the remainder can be incremented in step 625.

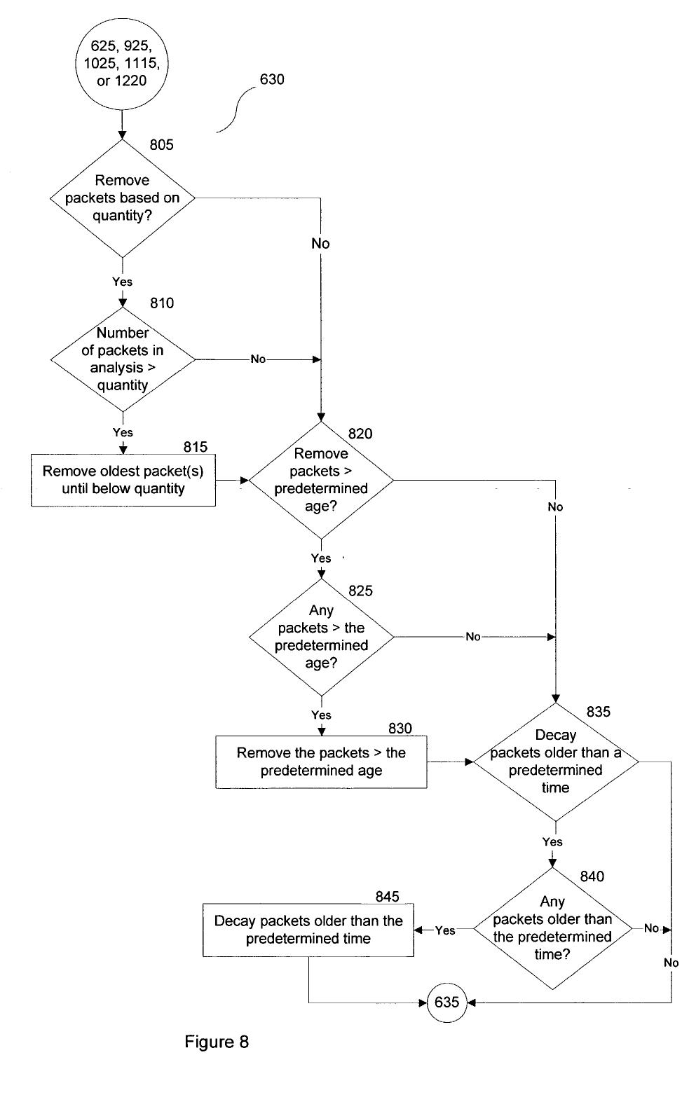

In step 630, data corresponding to certain packets can be removed from the analysis of method 310A, as discussed more fully below with reference to FIG. 8. For example, packets older than a specified time can be removed from the analysis. Alternatively, packets over a certain quantity can be removed from the analysis. Additionally, rather than removing those packets from the analysis, the weight of each packet can be decayed over time to provide more emphasis on current data packets.

In step 635, the decision module 206 determines whether it has collected enough data for statistical analysis. Basically, a few samples of data will not provide meaningful results for evaluating whether the network is under attack. Accordingly, the method 310A accumulates enough data to provide meaningful results. The exact amount of data required for meaningful results can be determined for each individual network. A typical amount used for meaningful results is 10% of the network's capacity.

In step 640, the decision module 206 calculates the standard deviation of the incremented values for each entry in the hash table. Then, in step 645, the decision module 206 determines whether the standard deviation is less than the threshold value for the data packet parameter. If not, then the method 310A has not detected an attack, step 650. Accordingly, the method branches back to step 615 to continue evaluating incoming data packets. If step 645 determines that the standard deviation is less than the threshold value, then the method 310A has detected an attack on the network, step 655. Accordingly, the method branches to step 315 (FIG. 3) to identify the source of the attack.

In an exemplary embodiment of the present invention, typical network traffic comprises “spikes” from a source IP address when a user connects to the network. The spikes occur because the user sends and receives a number of data packets during each connection to the network. Accordingly, a high standard deviation caused by the spikes created by a number of individual users indicates normal activity. On the other hand, a relatively flat distribution in the hash table can indicate abnormal network activity from sources that are more evenly distributed than typical traffic. For example, the flat distribution can indicate a network attack from a number of randomly generated sources. Accordingly, if the standard deviation of the values of the hash table is less than the threshold value, then the method 310A has detected an attack.

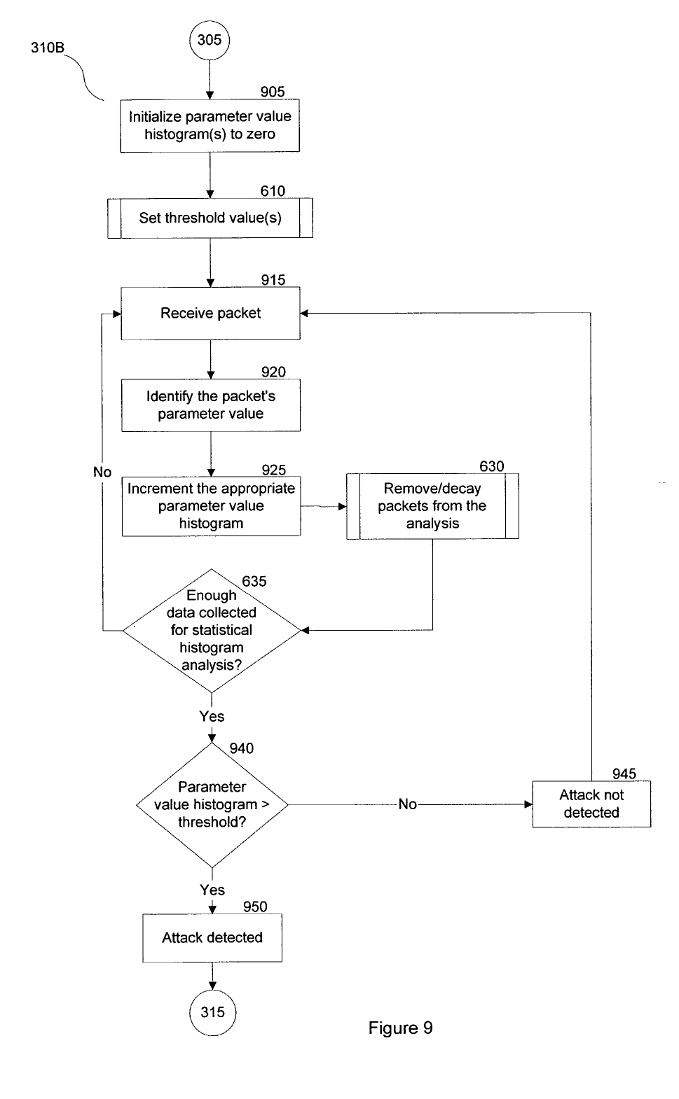

FIG. 7 is a flowchart depicting a method 610 for setting a threshold value according to an exemplary embodiment of the present invention, as referred to in step 610 of FIGS. 6 and 9-12. In step 705, the decision module 206 monitors normal network traffic to determine normal traffic patterns. In step 710, a statistical item can be selected. For example, the statistical item can comprise the standard deviation threshold value discussed above with reference to FIG. 6. Alternatively, the statistical item can comprise a data packet parameter value such as protocol or protocol flags, an error count value, or a packet ratio value, as discussed below with reference to FIGS. 9-12.

In step 715, the decision module 206 determines normal values for the selected statistical item based on the normal network traffic. In an exemplary embodiment, the normal values can comprise an average value for the selected statistical item over time. In that regard, the normal values can vary based on the particular network and the amount of traffic typically encountered by that network.

In step 720, a user determines the desired level of security and an allowable false positive percentage. The user balances the security level with the false positive percentage to develop a desired threshold for the selected item. For example, setting a lower threshold can increase the level of security by making the network highly sensitive to changes in the selected statistical item. However, that high sensitivity also increases the false positive results identified by the particular detection method. Accordingly, the user can establish the threshold based on the particular network's normal traffic and the user's security/false positive desires. In that regard, a preferred value for any of the thresholds does not exist. The user establishes a threshold for each item individually based on the particular network and current desires.

Thus, the user or the software module sets the threshold for the selected statistical item in step 725. In step 730, the method 610 determines whether to set a threshold for another statistical item. If yes, then the method branches back to step 710 to evaluate another statistical item. If no, then the method branches back to step 615, 915, 1015, 1115, or 1215, depending on the statistical item involved.

FIG. 8 is a flowchart depicting a method 630 for removing/decaying data packets from analysis according to an exemplary embodiment of the present invention, as referred to in step 630 of FIGS. 6 and 9-12. In step 805, the method 630 determines whether to remove packets based on predetermined quantity. If not, then the method branches to step 820, discussed below. If yes, then the method will remove packets from the analysis if the number of packets being analyzed is greater than the predetermined quantity. Accordingly, in step 810, the decision module 206 determines whether the number of packets included in the analysis is greater than the predetermined quantity. If not, then the method branches to step 820, discussed below. If yes, then the method branches to step 815. In step 815, the decision module 206 removes the oldest packets from the analysis until the number of packets is below the predetermined quantity. The method then branches to step 820, discussed below.

In step 820, the method determines whether to remove data packets that are older than a predetermined age from the analysis. If not, then the method branches to step 835, discussed below. If yes, then the method branches to step 825. In step 825, the decision module 206 determines whether any packets older than the predetermined age are included in the analysis. If not, then the method branches to step 835, discussed below. If yes, then the method branches to step 830. In step 830, the decision module 206 removes the packets older than the predetermined age from the analysis. The method branches to step 835.

In step 835, the method determines whether to decay packets older than a predetermined time. If not, then the method branches to step 635 (FIGS. 6, 9, 10, 11, or 12). If yes, then the method branches to step 840. In step 840, the decision module 206 determines whether any packets older than the predetermined time are included in the analysis. If not, then the method branches to step 635. If yes, then the method branches to step 845.

In step 845, the decision module 206 decays packets older than the predetermined time. The decayed packets then carry less weight in the analysis. For example, step 845 can comprise a one-half life decay. After the first predetermined time, the value of the packet's statistical weight can be reduced by one-half. After the second occurrence of the predetermined time, the value of the packet's statistical weight can be reduced again by one-half. As that process continues, the value of the statistical item continues to carry less weight and approaches zero. Using the method of FIG. 6 as an example, the source IP address of the data packet causes an entry in the hash table to be incremented by one. After the first occurrence of the predetermined time, the incrementation for the source IP address is reduced by one-half. Accordingly, the source IP address associated with that data packet carries less weight during the analysis.

After decaying the data packets older than the predetermined time, the method branches to step 635.

FIG. 9 is a flowchart depicting a method 310B for detecting a network attack according to another alternative exemplary embodiment of the present invention, as referred to in step 310 of FIG. 3. The method 310B can evaluate parameter values of incoming data packets to detect a network attack. For example, the parameter values can comprise a data packet's protocol or protocol flag.

In step 905, the decision module 206 initializes a parameter value histogram to zero. In that regard, each parameter value histogram corresponding to a different parameter value can be initialized to zero. In step 610, threshold values for each parameter value histogram can be established, as discussed above with reference to FIG. 7.

In step 915, the decision module 206 receives a data packet. In step 920, the decision module 206 identifies the value of the parameter associated with the data packet. For example, if the parameter value being evaluated is data packet protocol, then step 920 can identify whether the parameter value is TCP, UDP, or ICMP. Then, in step 925, the decision module 206 increments the parameter value histogram corresponding to the identified parameter value.

The method then proceeds to step 630 for removing/decaying data packets from the analysis, as discussed above with reference to FIG. 8. In step 635, the method determines whether the decision module 206 has collected enough data for statistical histogram analysis. If not, then the method branches to step 915 to collect additional data packets. If yes, then the method branches to step 940.

In step 940, the decision module 206 determines whether any portion of the parameter value histogram is greater than the threshold value. If not, then the method 310B has not detected an attack, step 945. Accordingly, the method branches to step 915 to evaluate additional data packets. If step 940 determines that a portion of the parameter value histogram is greater than the threshold value, then the method 310B has detected a network attack, step 950. Accordingly, the method proceeds to step 315 (FIG. 3) to identify a source of the attack.

According to an exemplary embodiment of the present invention, the parameter can comprise the data packet protocol. Thus, the parameter value of the data packet protocol can comprise TCP, UDP, or ICMP. Accordingly, step 610 of the method 310B can set threshold values for TCP, UDP, and ICMP protocols. As discussed above with reference to FIG. 7, those values can be established based on normal network traffic and a balance of network security with false positive identification. As an example, if the normal network activity comprises seventy-five percent TCP, twenty-four percent UDP, and one percent ICMP, then the threshold values could be set at eighty percent TCP, thirty percent UDP, and two percent ICMP.

Then, as the network receives data packets, the decision module 206 evaluates each data packet to identify its protocol (the parameter value), step 920. The decision module 206 then increments the appropriate protocol histogram according to the identified protocol of the data packet. For example, if the data packet's protocol is TCP, then the histogram corresponding to TCP is incremented. Step 940 determines whether the percentage of data packets comprising a TCP protocol is greater than the threshold TCP protocol value. If yes, then the method 310B has detected an attack. If not, then the method 310B continues monitoring additional data packets. The histogram and the protocol threshold can correspond to a percentage of the total network traffic matching the particular protocol.

As an alternative example, the method 310B can evaluate protocol flags associated with data packets of the network traffic. For example, the TCP protocol includes the following flags: a “syn” flag for starting a connection with the network; a “reset” flag for resetting a connection with the network; and a “fin” flag for finishing a network connection. Method 310B can evaluate proportions of the protocol flags compared to other protocol flags or compared to total network traffic of that protocol.

For example, the proportion of syn flags to fin flags normally comprises a ratio of about one to one. Accordingly, if a histogram indicates a significant deviation from the one to one ratio, then the method 310B has detected a network attack. As discussed above, the threshold values for actually detecting an attack based on the protocol flags can be set according to normal network traffic and a balance of security with false positive indications. As an alternative example, a high number of reset flags compared to normal traffic can indicate a network attack.

The method 310B illustrated in FIG. 9 is not limited to a parameter value of protocol or protocol flags. The parameter value can comprise any recurring information in data packets of network traffic.

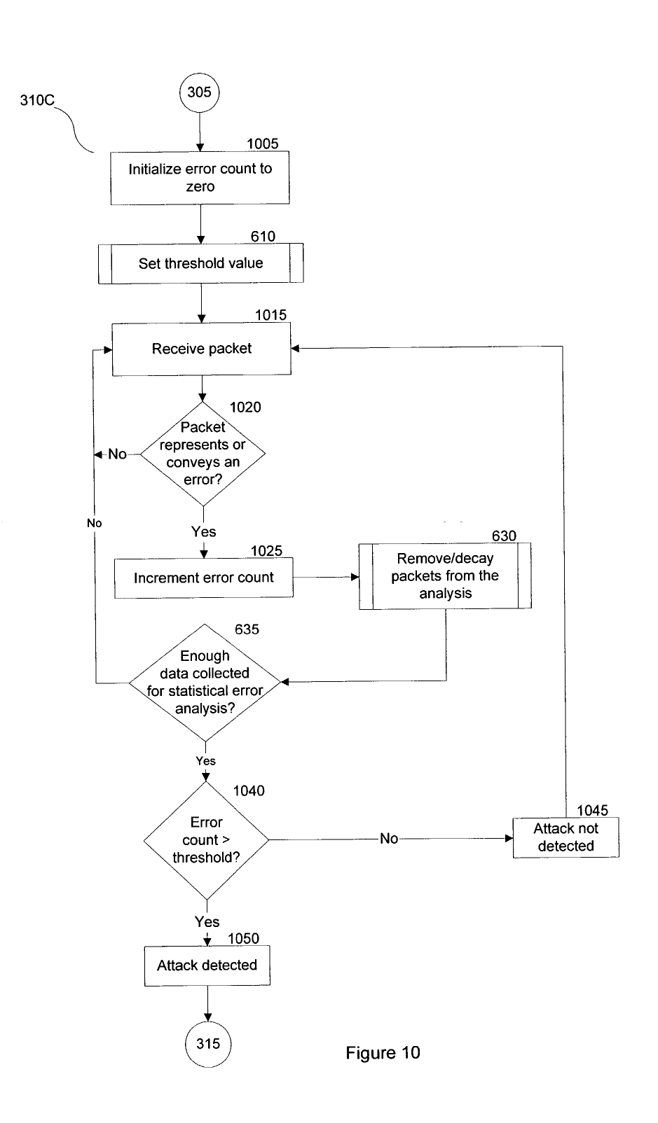

FIG. 10 is a flow chart depicting a method 310C for detecting a network attack according to another alternative exemplary embodiment of the present invention, as referred to in step 310 of FIG. 3. The method 310C can detect a network attack based on errors associated with data packets in the network traffic.

In step 1005, the decision module 206 can initialize an error count to zero. Then, in step 610, a threshold value for the error count can be established based on normal network traffic and a balance of network security and false positive indications, as discussed above with reference to FIG. 7.

In step 1015, the decision module 206 receives a data packet. In step 1020, the decision module 206 determines whether the packet represents or conveys an error. For example, if the data packet attempts contact with a port that does not exist on the network, then the network generates an error packet. Thus, if the data packet represents or conveys an error, then the method branches to step 1025 to increment the error count. If the data packet does not represent or convey an error, then the method branches to step 1015 to evaluate additional packets.

After step 1025, the method proceeds to step 630 for removing/decaying packets from the analysis, as discussed above with reference to FIG. 8. The method then proceeds to step 635. In step 635, the decision module 206 determines whether it has collected enough data for statistical error analysis. If not, then the method branches to step 1015 to evaluate additional packets. If yes, then the method branches to step 1040.

In step 1040, the decision module 206 determines whether the error count is greater than the threshold value. If not, then the decision module 206 has not detected an attack, step 1045. Accordingly, the method branches back to step 1015 to evaluate additional packets. If step 1040 determines that the error count is greater than the threshold value, then the method 310C has detected an attack, step 1015. Accordingly, the method branches to step 315 (FIG. 3) to identify a source of the attack.

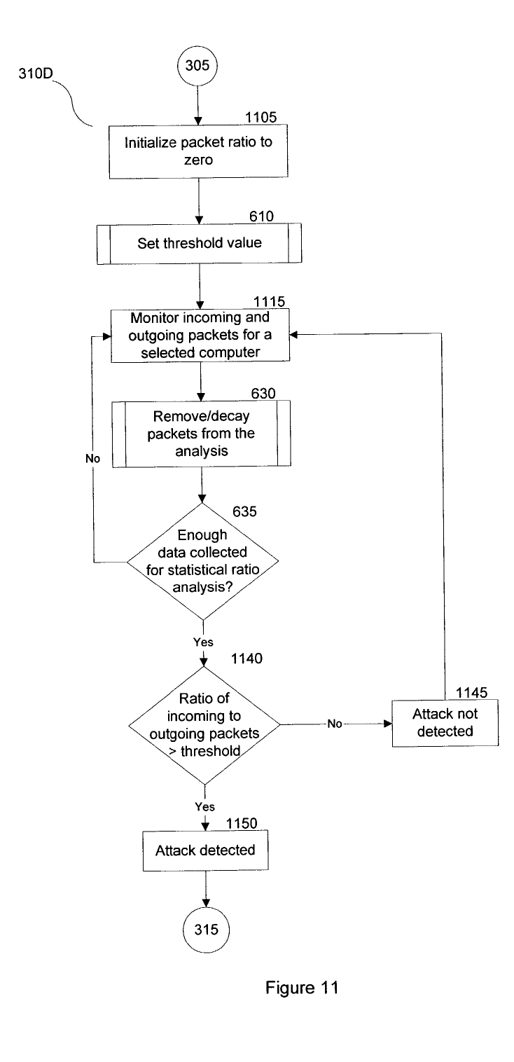

FIG. 11 is a flowchart depicting a method 310D for detecting a network attack according to another alternative exemplary embodiment of the present invention, as referred to in step 310 of FIG. 3. The method 310D can detect a network attack based on a ratio of incoming and outgoing data packets for a selected computer.

In step 1105, the decision module 206 can initialize a packet ratio to one. In step 610, a threshold value for the packet ratio can be set based on normal network traffic and a balance of network security and false positive indications, as discussed above with reference to FIG. 7.

In step 1115, the decision module 206 monitors incoming/outgoing packets for a selected computer. In that regard, the decision module 206 can count the number of incoming/outgoing data packets for the selected computer and can calculate a ratio incoming to outgoing packets. The method then proceeds to step 630 for removing/decaying packets from the analysis, as discussed above with reference to FIG. 8. Then, in step 635, the decision module 206, determines whether it has collected enough data for statistical ratio analysis. If not, then the method branches back to step 1115 to monitor additional data packets. If yes, then the method branches to step 1140.

In step 1140, the decision module 206 determines whether the ratio of incoming to outgoing data packets exceeds the threshold value. If not, then the method 310D has not detected an attack, step 1145. Accordingly, the method branches back to step 1115 to monitor additional data packets.

If step 1140 determines that the ratio of incoming to outgoing data packets is exceeds the threshold value, then the method 310D has detected an attack, step 1150. In alternative embodiments of the invention, the threshold criteria can be represented as a range of values or maximum and minimum values. Accordingly, the method proceeds to step 315 (FIG. 3) to identify the source of the attack.

Typical network traffic comprises two-way communications. Even if a requesting computer is downloading a large file from a source computer, the requesting computer communicates to the source computer to continue transmitting data packets from the large file. Accordingly, the ratio of incoming to outgoing data packets for a computer can be estimated based on observed, normal network traffic. Accordingly, if the ratio of data packets to a computer over the data packets from the computer is unreasonably high compared to the normal network traffic, then the method 310D can detect an attack on that computer.

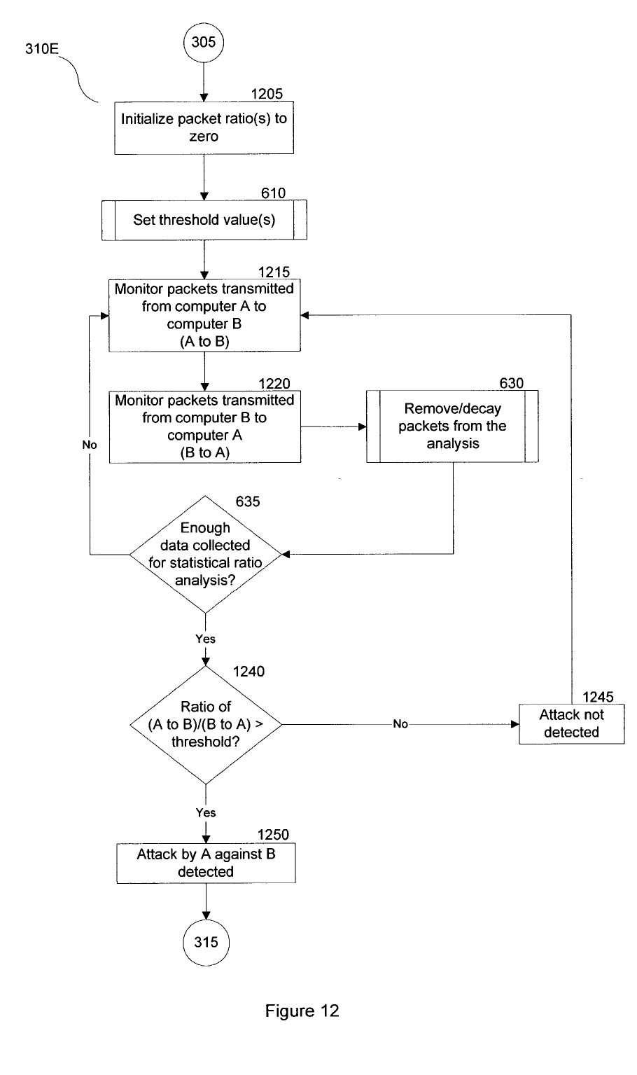

FIG. 12 is a flowchart depicting a method 310E for detecting a network attack according to another alternative exemplary embodiment of the present invention, as referred to in step 310 of FIG. 3. The method 310E also detects a network attack by monitoring incoming and outgoing data packets of a computer. However, the method 310E monitors incoming and outgoing data packets between two computers. For example, the method 310E can monitor data packets between computer A and computer B.

In step 1205, the decision module 206 can initialize a packet ratio to one. In step 610, a threshold value for each packet ratio can be set based on normal network traffic and a balance between network security and false positive indications, as discussed above with reference to FIG. 13. For example, a threshold value can be set for the ratio of packets transmitted from computer A to computer B over the packets transmitted from computer B to computer A.

In step 615, the decision module 206 can monitor data packets transmitted from computer A to computer B. In step 620, the decision module 206 can monitor packets transmitted from computer B to computer A. Basically, the decision module 206 counts the number of data packets transmitted during steps 615 and 620. The method then proceeds to step 630 for removing/decaying packets from the analysis, as discussed above with reference to FIG. 8. Then, in step 635, the decision module 206 determines whether it has collected enough data to perform statistical ratio analysis. If not, then the method branches back to step 1215 to monitor additional data packets. If yes, then the method branches to step 1240.

In step 1240, the decision module 206 determines whether the ratio of packets transmitted from computer A to computer B over the packets transmitted from computer B to computer A exceeds the threshold value. If not, then the method 310E has not detected an attack, step 1245. Accordingly, the method branches back to step 1215 to monitor additional data packets.

If step 1240 determines that the ratio of data packets transmitted from computer A to computer B over the data packets transmitted from computer B to computer A exceeds the threshold value, then the method 310E has detected an attack against computer B by computer A, step 1250. In alternative embodiments of the present invention the threshold can comprise a range of values or maximum and minimum values. Accordingly, the method branches to step 315 to determine the correct action against the source of the attack (FIG. 3).

In exemplary embodiments of the present invention, a system performing the methods 310D and 310E (FIGS. 11 and 12, respectively) can monitor simultaneously a number of computers. For example, the system can monitor the incoming/outgoing data packets for a number of different computers. Each computer can have its own associated threshold value based on normal network traffic for that computer. Accordingly, the system can detect an attack at any one of the computers using the method 310D. Additionally, the system can monitor incoming and outgoing traffic between any pair of computers in a multiple computer network. Accordingly, the system can detect an attack on one computer by another computer using the method 310E.

The methods 310A-310E described above can be combined in any combination to enhance the detection method by evaluating multiple statistical methods simultaneously.

Any standard graphical user interface (GUI) well known to those skilled in the art can be implemented for interacting with an A.N.T. system 106 over the Internet using an Internet browser. Alternatively, a GUI can be implemented with a central monitoring station (CMS) that can monitor one or more detection and countermeasure systems.

The present invention can be used with computer hardware and software that performs the methods and processing functions described above. As will be appreciated by those skilled in the art, the systems, methods, and procedures described herein can be embodied in a programmable computer, computer executable software, or digital circuitry. The software can be stored on computer readable media. For example, computer readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

Although specific embodiments of the present invention have been described above in detail, the description can be merely for purposes of illustration. Various modifications of, and equivalent steps corresponding to, the disclosed aspects of the exemplary embodiments, in addition to those described above, can be made by those skilled in the art without departing from the spirit and scope of the present invention defined in the following claims, the scope of which can be accorded the broadest interpretation so as to encompass such modifications and equivalent structures.

What is claimed is:

1. A computer-implemented method for detecting a flood-type denial of service attack against a host network, comprising the steps of:
hashing a data packet parameter of data packets in the network;
calculating a standard deviation of the hash table entries;
determining whether the standard deviation exceeds a threshold value; and
detecting the attack in response to a determination that the standard deviation is less than the threshold value.

2. The method according to claim 1, wherein the parameter value comprises a source IP address.

3. The method according to claim 1, wherein said sorting step comprises incrementing the hash table entries corresponding to the sortable results.

4. The method according to claim 1, further comprising the step of removing an entry from the hash table based on an age of the data packet corresponding to the removed entry.

5. The method according to claim 1, further comprising the step of decaying an entry in the hash table over time.

6. A computer-readable medium having computer-executable instructions for performing the steps recited in claim 1.

7. A computer-implemented method for detecting a flood-type denial of service attack against a host network, comprising the steps of:
identifying a parameter value for data packets in the network;
incrementing a histogram corresponding to the identified parameter value;
determining whether a portion of the histogram exceeds a threshold value; and
detecting the attack in response to a determination that the portion of the histogram exceeds the threshold value.

8. The method according to claim 7, wherein the parameter value comprises a protocol.

9. The method according to claim 7, wherein the parameter value comprises a protocol flag.

10. A computer-readable medium having computer-executable instructions for performing the steps recited in claim 7.

11. A computer-implemented method for detecting a flood-type denial of service attack against a host network, comprising the steps of:
counting errors associated with data packets in the network;
determining whether the error count exceeds a threshold value; and
detecting the attack in response to a determination that the error count exceeds the threshold value.

12. The method according to claim 11, further comprising the step of removing an error from the error count based on an age of the data packet associated with the removed error.

13. The method according to claim 11, further comprising the step of decaying an error in the error count over time.

14. A computer-readable medium having computer-executable instructions for performing the steps recited in claim 11.

15. A computer-implemented method for detecting a flood-type denial of service attack against a host network, comprising the steps of:
calculating a ratio of incoming to outgoing data packets for a computer of the network;
determining whether the ratio exceeds a threshold value; and
detecting the attack in response to a determination that the ratio exceeds the threshold value.

16. The method according to claim 15, further comprising the steps of:
determining a source of the attack; and
initiating a countermeasure against the source of the attack.

17. The method according to claim 16, wherein said initiating step comprises the step of preventing data packets from the source of the attack from entering the network.

18. The method according to claim 16, wherein said initiating step comprises the step of preventing data packets having a common port from entering the network.

19. The method according to claim 16, wherein said initiating step comprises the step of preventing data packets having a common protocol from entering the network.

20. The method according to claim 16, wherein said initiating step comprises the step of preventing data packets from reaching a target destination.

21. A computer-readable medium having computer-executable instructions for performing the steps recited in claim 15.

22. A computer-implemented method for detecting a flood-type denial of service attack against a host network, comprising the steps of:
calculating a ratio of incoming and outgoing data packets for a first computer of the network to incoming and outgoing data packets for a second computer of the network;
determining whether the ratio exceeds a threshold value; and
detecting the attack in response to a determination that the ratio exceeds the threshold value.

23. The method according to claim 22, further comprising the steps of:
determining a source of the attack; and
initiating a countermeasure against the source of the attack.

24. The method according to claim 1, further comprising the step of removing an entry form the hash table based on the quantity of entries in the hash table.
